(19) United States
(12) Patent Application Publication
(10) Pub. No.: US 2026/0350509 A1
(43) Pub. Date: Nov. 5, 2026

(54) AD HOC WORKFLOW TASK INDUCTION

(71) Applicant: Box, Inc., Redwood City, CA (US)

(72) Inventors: Andrew Dunn, Santa Cruz, CA (US); Virender Gupta, Morganville, NJ (US)

(73) Assignee: Box, Inc., Redwood City, CA (US)

(21) Appl. No.: 19/195,189

(22) Filed: Apr. 30, 2025

(51) Int. Cl. G06Q 10/0631

(52) U.S. Cl. CPC G06Q 10/06316; G06Q 10/063114; G06Q 10/06312

(57) ABSTRACT

Methods, systems and computer program products for managing workflows. The present disclosure describes techniques used in systems, methods, and in computer program products for an improved approach to implement workflows, where the workflow system is permitted to dynamically create ad hoc sub-tasks.

### BACKGROUND

The high-performance computing, storage, and networking capabilities characteristic of today's computing environments have impacted the way personal and corporate computer-readable content objects (e.g., documents, spreadsheets, images, programming code files, etc.) are created, stored, and shared. The capabilities of these environments facilitate interactions (e.g., authoring, editing, viewing, etc.) that are performed over content objects by trusted users (e.g., collaborators) on a variety of user devices such as mobile phones, tablets, laptop computers, desktop computers, and/or other devices.

In many cases, commonly-occurring interactions over the content objects are organized into automated workflows. Such workflows often specify an ordered sequence or “flow” of operations to be performed on the content objects, which operations are often invoked by user interactions with the content objects. Interactions with a particular content object may be performed by one user, multiple users, and/or even autonomously by one or more computing entities (e.g., processes, agents, applications, etc.). Moreover, such interactions may span across multiple projects, and/or multiple departments, and/or multiple enterprises.

In the modern workplace, workflow management systems are indispensable tools used to coordinate tasks, track progress, and ensure efficiency in project execution. These systems rely on predefined workflows, which consist of a series of tasks and steps designed to achieve specific objectives. By enforcing strict sequences and dependencies, they offer a structured approach to managing complex projects. However, this rigidity often fails to address the dynamic nature of real-world processes, where unexpected tasks frequently arise. In such cases, users must resort to manual workarounds, such as creating independent tasks outside the workflow, leading to inefficiencies and potential oversight.

Traditional workflow systems are designed to handle predefined tasks with minimal variation, limiting their ability to adapt to changing requirements. For instance, if an unforeseen issue arises within a specific workflow step, such as additional approvals, reviews, or troubleshooting tasks, users cannot easily integrate these changes into the existing structure. This lack of flexibility results in disruptions and complicates task tracking, as new tasks often exist outside the main workflow, disconnected from the step or process that necessitated them.

The limitations of existing systems are particularly evident in collaborative and fast-paced environments where adaptability is crucial. For example, in a product development cycle, an unexpected design revision might require additional quality checks, technical documentation updates, coordination with external stakeholders, and/or the inclusion of additional approvers for the design revision. Without a system that allows for seamless integration of such ad hoc tasks, these needs are often handled through emails, spreadsheets, or informal communication, increasing the likelihood of errors, duplication, or missed steps.

Although some modern systems offer limited customization options, these are typically restricted to predefined workflows that must be manually updated and re-approved. This process can be time-consuming and cumbersome, especially when changes are required mid-execution. Furthermore, many systems do not provide mechanisms to track ad hoc tasks in relation to the broader workflow, making it challenging to assess their impact on timelines and deliverables.

There is a growing need for a workflow processing system that bridges the gap between predefined workflows and real-world adaptability. Such a system should enable users to dynamically create, integrate, and manage ad hoc tasks while maintaining the integrity and visibility of the overall workflow. By addressing this unmet need, the invention described herein aims to provide a more flexible and robust solution, empowering teams to respond to unforeseen challenges without compromising efficiency or traceability.

### SUMMARY

The present disclosure describes techniques used in systems, methods, and in computer program products for an improved approach to implement workflows, where the workflow system is permitted to dynamically create ad hoc sub-tasks.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 shows an architecture of a system to implement ad-hoc task induction for a workflow according to some embodiments of the invention.

FIG. 2 shows a high-level flowchart of some embodiments of the invention. At 202, a workflow is created.

FIG. 3 shows a detailed flowchart of some embodiments of the invention.

FIG. 4 shows a flowchart of an approach to implement and track the ad hoc sub-tasks according to some embodiments of the invention.

FIGS. 5A-C describe data structures that may be used to implement and track the ad hoc sub-tasks according to some embodiments of the invention.

FIG. 6A and FIG. 6B present block diagrams of computer system architectures having components suitable for implementing embodiments of the present disclosure, and/or for use in the herein-described environments.

### DETAILED DESCRIPTION

The present disclosure describes an invention which is a workflow processing system that dynamically integrates ad hoc sub-tasks into predefined workflows by treating them as data structure objects. These objects are linked to their respective parent tasks using a relational structure, allowing for seamless tracking, dependency management, and real-time updates. This design ensures that the integrity of the workflow remains intact while enabling flexibility to accommodate unforeseen requirements.

In some embodiments, workflows are implemented whereby additional sub-tasks can be created on an ad-hoc basis, and these dynamically created sub-tasks are then linked to their parent tasks. These sub-tasks can be assigned out to be performed, e.g., by an individual assigned to the parent task, and then upon completion of the sub-tasks, the parent task can then be completed.

This approach therefore solves the problems associated with conventional workflow systems, where the workflows themselves are extremely rigid, and it is not possible to dynamically add new tasks on an ad-hoc basis to existing workflows. As described in more detail below, the ad-hoc sub-tasks can be tracked and monitored the same was as existing tasks within the workflow are tracked and monitored.

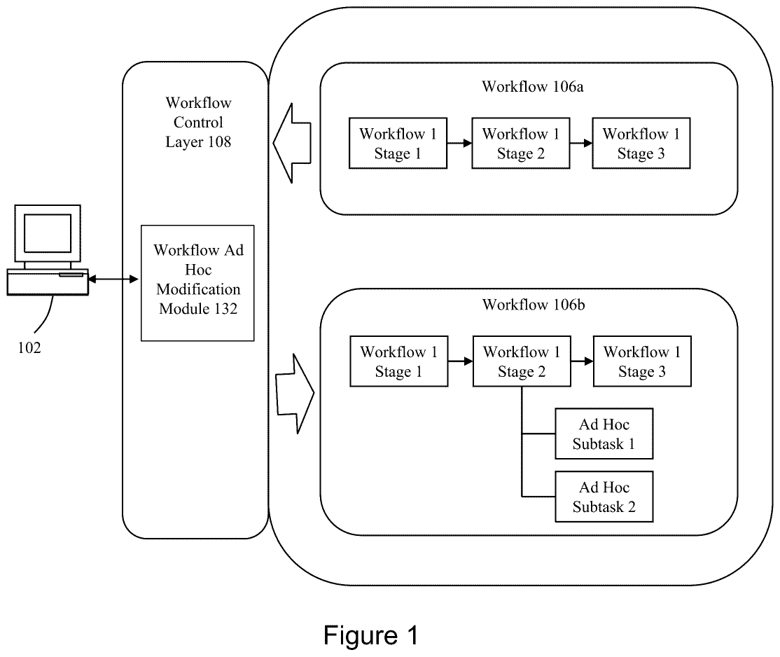

FIG. 1 shows an architecture of a system to implement ad-hoc task induction for a workflow according to some embodiments of the invention. The architecture includes a workflow control layer 108 to control the operation and implementation of one or more workflows, such as workflow 106a. Workflow 106a currently includes three workflow stages, including workflow stage 1, workflow stage 2, and workflow stage 3.

The current architecture can be used to create additional sub-tasks for any task within a workflow, such that sub-tasks can be created for any of stages 1, 2, or 3. For example, as shown in this figure, a modified workflow 106b results from the addition of sub-tasks to stage 2 of the workflow. In particular, ad hoc sub-task 1 and ad hoc sub-task 2 have been added to stage 2 of the workflow 106b.

The workflow control layer 108 include a workflow ad hoc modification module 132 that has logic to implement the ad hoc sub-tasks for workflows. The data structures for representing the workflows and/or the ad hoc sub-tasks are stored within the workflow task database 134. In some embodiments, the ad hoc sub-tasks in the system are implemented as distinct data structure objects within the workflow task DB 134. Each sub-task object contains metadata and attributes necessary for task management. These attributes include, for example: (a) Task Identifier (ID): An identifier to ensure the sub-task can be tracked independently; (b) Parent Task Reference: A pointer or relational link to the parent task object. This establishes a direct relationship between the sub-task and the workflow step it augments; (c) Task Metadata: Descriptive attributes such as task name, description, priority, status, and assignee(s); (d) Dependencies: A list of task IDs that must be completed before the sub-task can proceed; (e) Time Attributes: Priority level, Start date, due date, and estimated duration for scheduling purposes; (f) Audit Information: Metadata capturing the creation timestamp, creator details, and any modifications. The system's workflow engine uses these attributes to organize and execute tasks while maintaining a comprehensive view of all relationships and dependencies.

In some embodiments, the sub-tasks are directly linked to their parent tasks through a parent-child data structure model. This hierarchical structure allows the workflow engine to track sub-tasks as extensions of the parent task while preserving their independent attributes. The relationship is implemented using a one-to-many mapping in the data model. Each parent task maintains a list of references (IDs) to its associated sub-tasks. Conversely, each sub-task contains a single reference to its parent. This bi-directional linking ensures consistency and traceability.

The workflow control layer within the system may include a workflow engine that processes tasks by iterating through the data structures representing the workflow. When a parent task with linked sub-tasks is encountered, the engine treats the sub-tasks as dependent units. With regards to execution logic, the workflow engine ensures that all sub-tasks linked to a parent task are completed before confirming that the parent task is finished. For dependency resolution, the workflow engine evaluates the dependencies of sub-tasks and adjusts the execution sequence accordingly. For example, if a sub-task depends on the completion of another sub-task, it is scheduled later in the queue. Real-time updates may be implemented, where any changes to sub-tasks, such as updates to status or dependencies, are propagated through the workflow in real-time, ensuring that downstream tasks reflect the latest information.

It is noted that the ad hoc sub-tasks may be created dynamically and in real-time. When users identify a need for an ad hoc sub-task, they interact with the Dynamic Task Generator via a User Interface (UI). Upon submission, the system creates a new sub-task object with the specified attributes and links it to the parent task. The creation process may involve some or all of the following actions: (a) Validation: Ensuring required attributes such as task name, parent reference, and due date are provided; (b) Instantiation: Generating a sub-task object and assigning it a unique identifier; (c) Linking: Adding the sub-task's ID to the parent task's list of sub-tasks and updating the workflow database.

Sub-Task hierarchy management may be performed, where the system maintains and manages relationships between tasks and sub-tasks in a structured format. Relationship update actions are also performed, where when a sub-task is added, modified, or removed, the system updates the parent task and propagates changes to related objects.

The system may also perform impact analysis, where evaluation is performed of the impact of sub-task changes on the parent task and downstream workflow. For instance, adding a high-priority sub-task might delay the parent task's completion, prompting the manager to adjust timelines.

In some embodiments, a UI is provided to the user at user station 102 that presents tasks and sub-tasks in a hierarchical view, with expandable and collapsible nodes representing parent-child relationships. This visualization helps users understand the workflow structure and navigate between tasks. A Parent Task View may be provided, which displays the parent task's details, along with a list of its sub-tasks. A Sub-Task View may also be provided, which allows users to view and edit sub-task attributes, such as priority or dependencies. The UI may also provide an interface for defining new sub-tasks, including dropdowns for selecting the parent task and specifying dependencies.

It is possible that conflicts may occur for concurrent tasks and sub-tasks. Some embodiments provide a mechanism to implement concurrency and conflict resolution. In effect, the system supports concurrent edits to workflows while preventing conflicts. For example, a locking mechanism can be used where tasks and sub-tasks being edited are temporarily locked to prevent simultaneous updates. In addition, conflict detection can be performed, where if conflicting changes are detected (e.g., two users modifying the same sub-task), the system alerts users and provides options for resolution.

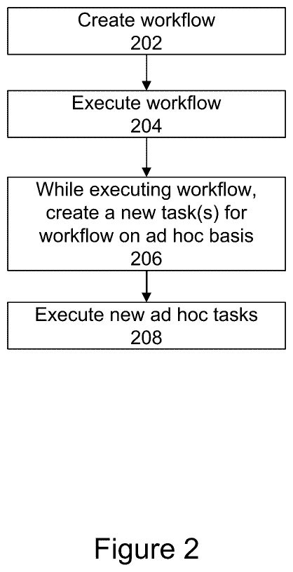

FIG. 2 shows a high-level flowchart of some embodiments of the invention. At 202, a workflow is created. The workflow comprises any number of tasks that are programmed into the sequence of stages and actions of the workflow. The workflow itself is a series of steps, decision points, and assignments that define the process from initiation to completion. The creation of the workflow (202) may involve defining the individual tasks, the order in which they are to be performed, the dependencies between tasks, and the resources or individuals responsible for completing each task. This structured approach ensures that the process is carried out in a consistent and organized manner.

At 204, the workflow is executed. For example, a triggering action may be used to begin execution of the workflow. Workflow execution (204) is the process of carrying out the defined workflow. This typically involves initiating the workflow based on a specific trigger or event, and then automatically or manually progressing through the various stages and tasks as defined in the workflow. The execution may be monitored by a workflow management system, which tracks the status of each task, ensures that dependencies are met, and provides notifications or alerts as needed.

At 206, while in the midst of execution of the workflow, one or more new tasks are created for the workflow. The new tasks are created on an ad hoc basis for the workflow. The tasks may be implemented as sub-tasks for existing tasks in the workflow. This is a key aspect of the invention. During the execution of the workflow, new requirements or unforeseen circumstances may arise that necessitate the creation of additional tasks. These ad hoc tasks (206) are not defined in the original workflow design but are dynamically added to address the specific situation. In some embodiments, these new tasks are created as sub-tasks of a parent task that is already part of the workflow.

At 208, the newly created ad hoc tasks are executed. The ad hoc tasks may be used to implement any actions in conjunction with any of the other tasks within the workflow. For instance, the ad hoc tasks may be used to perform new tasks that do not already exist in the workflow, and involve tasks to be performed by individuals (assignees) that do not have already have other existing task or roles within the workflow. Once the ad hoc tasks are created, they need to be executed (208) in order to fulfill their purpose within the workflow. The execution of these tasks may involve assigning them to specific individuals or resources, determining their priority, and tracking their progress and completion. These ad hoc tasks can be integrated into the ongoing workflow execution, ensuring that they are performed in a timely and efficient manner and do not disrupt the overall flow of the process.

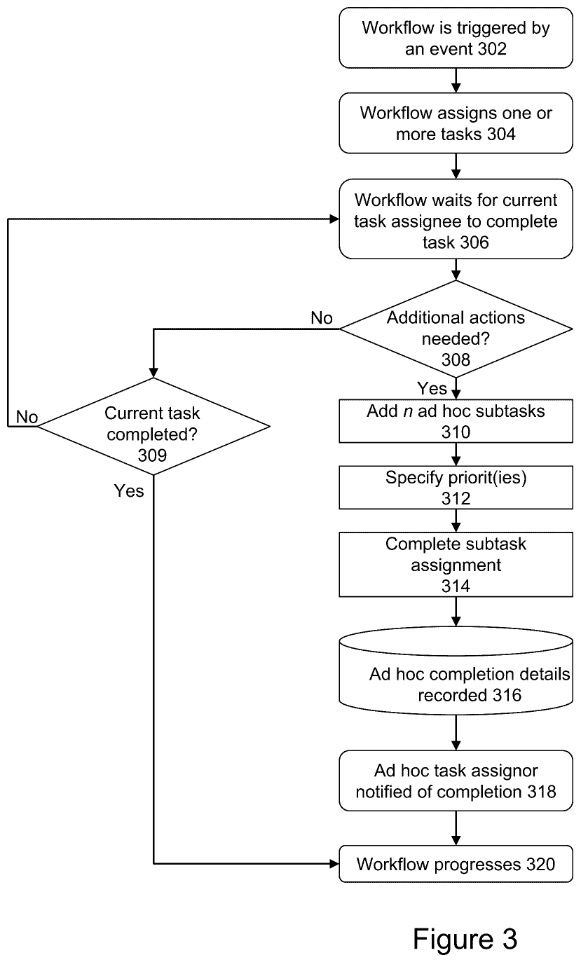

FIG. 3 shows a detailed flowchart of some embodiments of the invention. At 302, a workflow is triggered by an event. The event could be any suitable event that is used to initiate or trigger an event. The event may be a manually created event, or may be an event that is automatically created based upon automation in a computing system. The triggered event may include any number of workflow stages having one or more tasks. This triggering event acts as the starting point for the workflow, setting in motion the series of predefined or dynamically created tasks that need to be performed. The nature of the triggering event can vary widely depending on the specific workflow and its purpose.

At 304, the workflow assigns one or more tasks. The tasks may be assigned to one or more individuals or entities. The one or more assignees are assigned to complete the assigned task. The assignment process involves identifying the appropriate resources or individuals to carry out each task within the workflow. This may be done automatically, based on predefined rules or algorithms, or manually, by a workflow manager or other authorized user. The assignment process ensures that each task is delegated to the right person or team, taking into account their skills, availability, and workload.

At 306, the workflow waits for the assigned task assignee(s) to complete the task. What is notable here is that in some embodiments, the workflow is performing the assignment of the task. After the tasks have been assigned, the workflow typically enters a waiting state (306), where it monitors the progress of each assigned task. The workflow system may track the status of each task, including whether it is pending, in progress, or completed. This waiting period is crucial for ensuring that tasks are completed in the correct sequence and that any dependencies between tasks are properly managed.

At 308, a determination is made whether there are additional actions-not programmed into the workflow-that are needed. These additional tasks may need other individuals to complete some action. During the execution of a task, it may become apparent that additional actions are required that were not originally in the workflow design (308). This could be due to a variety of reasons, such as unexpected problems, new information, or changing requirements.

If the answer is that there are no such additional tasks, then the workflow proceeds as originally programmed. Therefore, at 309, a determination is made whether the current assignee has completed the assigned task. If not, the process loops back to 306 and continues as previously described. However, if the task assignee has completed the task, then the workflow progresses at 320. This may cause the workflow to move to the next sequential task, thereby looping back to 304 for the next task (not shown in figure). If no additional tasks are needed, the workflow follows its originally defined path. The system checks for task completion (309), and if the task is not complete, it continues to wait (306). Once the task is completed, the workflow moves on to the next stage (320), which may involve assigning a new task (304).

If the answer at 308 is that there are additional tasks that need to be performed, then the process proceeds to 310 to add one or more new ad hoc tasks to the current task. The new ad hoc tasks may be added by one or more assignees, e.g., where the ad hoc sub sub-tasks are manually added by the assignees. Alternatively, the ad hoc tasks may be added using a rule and/or other types of automation. When additional tasks are required, the system allows for the dynamic creation of these ad hoc tasks (310). These tasks can be added manually by the current task assignee or automatically through predefined rules or automation mechanisms.

It is noted that the new task that is added to the workflow may be completed independent of each other and/or the parent task. In addition, the ad hoc sub-task may be implemented in any desired or suitable order. The newly created ad hoc tasks can be designed to be completed independently of each other or the parent task. This flexibility allows for parallel processing and efficient handling of the additional work. The order in which these sub-tasks are executed can also be determined dynamically, based on factors such as priority, dependencies, and resource availability.

At 312, the newly created ad hoc sub-tasks are assigned to one or more assignees. In some embodiments, it is the current task assignee that performs the assignment to the new one or more assignees. Alternatively, the assignment is performed automatically based upon a rule that selects an assignee from a list of possible assignees. Each ad hoc sub-task is assigned to a specific individual or resource (312). This assignment can be done by the assignee of the parent task or automatically, using rules or algorithms that select the most appropriate assignee based on predefined criteria.

At 314, a priority order may be assigned to the sub-tasks if more than one new sub-task has been created. In addition, the dependency of the sub-tasks to each other may be specified at this step. In some embodiments, it is the current task assignee that designates the priority order and/or dependencies. Alternatively, this is performed automatically based upon a rule or other automation technique. If multiple ad hoc sub-tasks are created, their order of execution and dependencies may need to be defined (314). This can be done manually by the parent task assignee or automatically, based on rules or predefined dependencies.

The assignees for the sub-tasks then proceed to perform the assigned sub-tasks. At some point in time, at 314, the sub-task assignee(s) may complete the assigned sub-tasks. At 316, the sub-tasks completion details are recorded in a workflow log. The assignees for the ad hoc sub-tasks then perform their assigned tasks. Upon completion, the details of the sub-task completion are recorded in a workflow log (316). This log provides a record of the work that has been done, including who did it, when it was done, and any relevant information.

Thereafter, at 318, the ad hoc task assignor is notified that the ad hoc sub-tasks have been completed. At this point, at 320, the workflow can then progress. This may involve, for example, completion of the parent task and then the progression of the workflow to any subsequent stages past the parent task. Once all ad hoc sub-tasks are completed, the assignor of the ad hoc tasks is notified (318). This notification triggers the continuation of the main workflow (320). The parent task can then be completed, and the workflow can proceed to the subsequent stages.

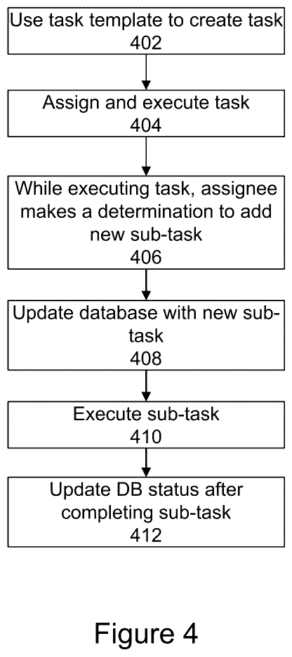

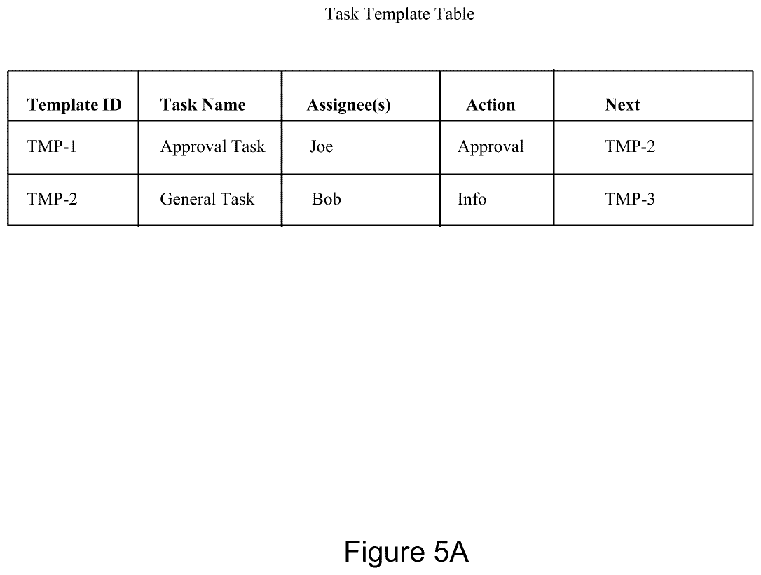

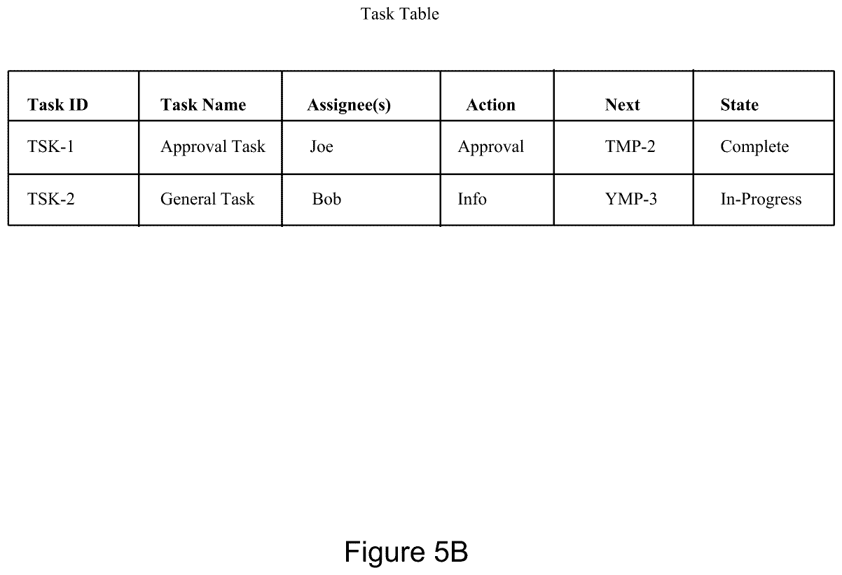

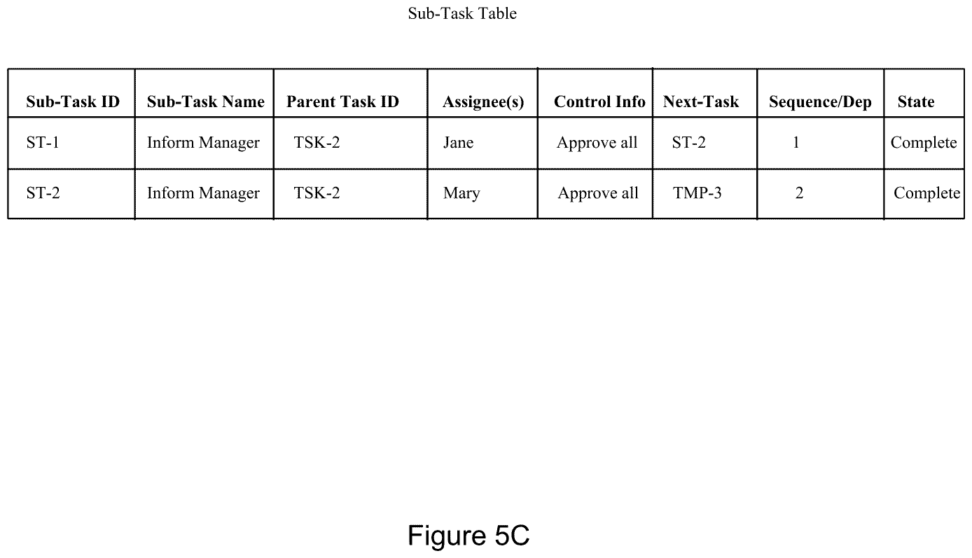

FIG. 4 shows a flowchart and FIGS. 5A-C describe the data structures that may be used to implement and track the ad hoc sub-tasks according to some embodiments of the invention. The general idea is that there is a set of interconnected data structures that can be used to instantiate, track, and monitor tasks and sub-tasks within the system.

FIG. 5A shows a more detailed view of a task template table. The task template table provides a structured mechanism for defining and managing different types of tasks within the workflow system. Each row in this table represents a distinct task template, which serves as a blueprint for creating individual task instances. As new task types are introduced or existing ones are modified, the template information is stored and updated within this table, ensuring that the system can accommodate a wide range of task requirements. This table is important for establishing a standardized approach to task creation, promoting consistency and efficiency within the workflow.

Each row of the task template table contains specific attributes that define the characteristics of a task type. These attributes are organized into columns, with each column representing a different aspect of the task. In this illustrative example, the table includes a Template Identifier, which is a unique identifier for each task template, allowing the system to quickly retrieve and reference the template when creating new task instances. This identifier acts as a primary key, ensuring that each template can be easily located and utilized by the system. A Task Name provides a descriptive name for the task type, offering a user-friendly label. This name helps users to easily understand the purpose and function of the task.

An optional Assignee column specifies the default assignee or assignee role for this task type, although this information may be present in the task template, the task table, or both, depending on specific workflow requirements. The inclusion of an assignee at the template level can streamline the task assignment process, automatically assigning tasks to the appropriate individuals or groups. The Action column describes the specific action or operation that needs to be performed for this task type, potentially including instructions, scripts, or references to executable code. This ensures that the task is executed in a consistent and predefined manner.

Finally, the Next Task column identifies the subsequent task or tasks to be executed upon completion of the current task, defining the sequential flow of the workflow. This column is essential for maintaining the correct order of operations within the workflow, ensuring that tasks are performed in the intended sequence and that dependencies are properly managed. The task template table, therefore, serves as a central repository for task type definitions, enabling the system to create and manage tasks effectively.

FIG. 5B shows a more detailed view of a task table. The task table stores information about individual task instances, which are created based on the task templates defined in the task template table (FIG. 5A). Each row in the task table represents a specific occurrence of a task within the workflow, capturing its unique attributes and state. This table is dynamic, with new rows being added as new task instances are created and updated as tasks progress through their lifecycle. It provides a real-time view of the status of each task within the workflow.

The task table contains columns that provide detailed information about each task instance. These columns may include a Task Identifier, a unique identifier for each task instance, enabling the system to track and manage individual tasks throughout their lifecycle. This identifier is crucial for distinguishing between different instances of the same task type. The Task Name is derived from the task template, providing a consistent naming convention. The Assignee column specifies the user or group assigned to perform the task. This assignment may be based on the default assignee specified in the task template or may be dynamically determined based on workflow rules or user input.

The Action column details the action to be performed for the task instance, as defined in the task template. This ensures that the correct operation is carried out for each task. The Next Task column indicates the next task or tasks in the workflow sequence. This maintains the flow of the workflow, ensuring that tasks are executed in the correct order. Lastly, the Current State column reflects the current status or state of the task, such as “Pending,” “In Progress,” “Completed,” or “Failed.” This column provides a critical overview of the progress of each task, allowing users and the system to monitor the workflow's execution.

FIG. 5C shows a more detailed view of a sub-task table. The sub-task table stores information about ad hoc sub-tasks, which are dynamically created and associated with parent tasks in the task table. Each row in the sub-task table represents a specific sub-task instance, providing details about its attributes and relationships. This table is essential for managing the flexible and dynamic nature of workflows, where sub-tasks can be added as needed.

The sub-task table includes columns such as Sub-Task Identifier, a unique identifier for each sub-task instance, and Sub-Task Name, a descriptive name for the sub-task. The Parent Task column references the parent task in the task table, establishing the relationship between the sub-task and its parent. This ensures that the sub-task is correctly linked to the appropriate task within the workflow. The Assignee column specifies the user or group assigned to perform the sub-task.

The Control Information column stores any additional parameters or data necessary to control the execution or behavior of the sub-task. This might include configuration settings, input values, or references to specific resources required by the sub-task. The Next Task/Sub-Task column indicates the next task or sub-task in the sequence, if applicable, allowing for the creation of sub-workflows. Columns for Ordering/Priority/Dependencies specify the order, priority, or dependencies of the sub-task relative to other sub-tasks or its parent task. This enables the system to manage complex dependencies and ensure that sub-tasks are executed in the correct order.

Finally, the Current State column reflects the current status or state of the sub-task, providing a real-time view of its progress. The sub-task table, in conjunction with the task table and task template table, provides a comprehensive framework for managing both predefined and dynamically created tasks within a workflow system, enabling greater flexibility and adaptability.

FIG. 4 shows a flowchart of an approach to implement ad hoc sub-tasks using the data structures that were described in these figures. This flowchart illustrates the process by which tasks and sub-tasks are created, assigned, executed, and managed within the workflow system, with a particular emphasis on the dynamic creation of sub-tasks. The process begins with the creation of a task, followed by its assignment to a user, the potential creation of ad hoc sub-tasks, the execution and completion of these sub-tasks, and finally, the completion of the parent task.

At 402, the user may create a task using the task template. A user interface may be presented to the user that allows the user to select a specific type of task to create in the workflow. The user interface would access the task template table to populate the selection of options available to the user. This step involves the user initiating a new task, referring to the task template table to ensure that the task is created with the correct attributes and structure. The task template provides a blueprint, and the user's selection determines which template is used for the new task.

This would result in the inclusion of a new entry within the task table for each new task that is created. Each entry for a new task would be populated based upon attributes for the new task identified by the user. For example, at 404, the new task may be assigned to an individual to handle that task. As a result, the entry for that task, in the assignee column, would identify the user that is assigned to handle the task. The task table is updated with the new task instance, and relevant details such as the assignee are recorded. This assignment ensures that the task is directed to the appropriate person or team for execution, and the assignee column in the task table reflects this assignment.

When executing that task, the task assignee may decide (at 406) that one or more additional sub-tasks are needed. Therefore, the task assignee will create the new sub-tasks on an adhoc basis. This decision point highlights the dynamic nature of the workflow, where tasks can evolve and require additional steps not initially planned. The task assignee has the authority to create these sub-tasks, demonstrating the system's flexibility. This flexibility is crucial in real-world scenarios where unforeseen complexities or dependencies may arise during task execution.

At 408, the database would be updated to include entries in the sub-task table for the new ad hoc sub-tasks. In particular, each new ad hoc sub-task would be represented by a separate entry within the sub-task table. Each entry for a new sub-task would be populated based upon attributes for the new sub-task identified by the task assignee. For example, the new sub-task may be assigned to an individual to handle that sub-task, and the entry for that sub-task, in the assignee column, would identify the user that is assigned to handle the sub-task. The sub-task table is then updated to reflect these newly created sub-tasks, with each sub-task's details, including its assignee, being recorded. This ensures that all sub-tasks, even those created dynamically, are tracked and managed within the system.

At 410, the sub-task would be executed by the sub-task assignee. Eventually, the sub-task assignee may complete the sub-task. At this point, at 412, the status field for the sub-task would be updated to reflect the new status of the sub-task. Therefore, once all of the sub-tasks for a given task have been completed, the parent task can then be completed. The sub-tasks are carried out, their status is tracked, and upon their completion, the parent task can proceed towards completion. This ensures that all necessary components of a task, including dynamically added sub-tasks, are finished.

The process illustrated in FIG. 4 emphasizes the system's ability to handle dynamic workflow adjustments. By allowing task assignees to create sub-tasks on an ad hoc basis, the system can adapt to evolving project needs and unforeseen circumstances. This capability ensures that workflows remain efficient and effective, even when faced with complexities that were not initially anticipated during the task template creation phase.

Furthermore, the use of separate tables-the task template table, the task table, and the sub-task table-provides a clear and organized structure for managing tasks and their associated sub-tasks. This structured approach not only facilitates efficient data retrieval and manipulation but also enhances the overall maintainability and scalability of the workflow system. The relationships between these tables, particularly the link between the task table and the sub-task table through the Parent Task column, are crucial for maintaining the integrity of the workflow and ensuring that sub-tasks are correctly associated with their respective parent tasks.

The updating of the sub-task status at 412 is a critical step in the process. This status update allows for real-time tracking of the progress of each sub-task, providing valuable information to both the sub-task assignee and the assignee of the parent task. This information can be used to monitor the overall progress of the task, identify potential bottlenecks or delays, and make informed decisions about resource allocation and task prioritization.

The completion of the parent task is contingent upon the completion of all its associated sub-tasks. This dependency ensures that all aspects of a task are thoroughly addressed before it is marked as complete. This mechanism helps to maintain the quality and integrity of the workflow, preventing tasks from being prematurely closed and ensuring that all necessary steps are taken.

In summary, FIG. 4 provides a detailed description of the process by which ad hoc sub-tasks are implemented within the workflow system. This process leverages the structured data provided by the task template, task, and sub-task tables to enable dynamic task management, flexible workflow adaptation, and comprehensive task tracking. The ability to create and manage sub-tasks on an ad hoc basis enhances the system's adaptability and ensures that workflows can effectively handle the complexities of real-world projects.

Therefore, what has been described is an improved approach to implement workflows, where the workflow system is permitted to dynamically create ad hoc sub-tasks.

The process implemented by the invention involves a series of steps that are performed to manage and execute tasks and sub-tasks within a workflow. As detailed in the description of FIG. 4, this process includes: creating a task using a task template, assigning the task to a user, dynamically creating sub-tasks as needed, executing the sub-tasks, updating the status of the sub-tasks, and completing the parent task upon completion of all sub-tasks. This series of steps represents a practical application of managing complex workflows, and it provides a tangible result by enabling more flexible and adaptable task management.

The invention enhances the operation of a computing system, specifically the CPU and memory utilization, through its dynamic sub-task management. By allowing task assignees to create sub-tasks on an ad-hoc basis, the system optimizes CPU processing by enabling a more granular and responsive allocation of computational resources. When a task requires additional processing, the CPU can be directed to handle these sub-tasks immediately and efficiently, rather than waiting for a predefined workflow or task to be completed. This dynamic allocation reduces CPU idle time and allows for quicker processing of urgent or emergent task requirements.

Furthermore, the invention can lead to reduced memory consumption. Instead of pre-allocating memory for a maximum potential workflow complexity, the system only allocates memory for the sub-tasks that are actually created. This just-in-time allocation of memory, driven by the dynamic creation of sub-tasks, prevents memory wastage and allows the computing system to handle more complex workflows within the same memory footprint. The structured approach to managing tasks and sub-tasks, facilitated by the task template table, task table, and sub-task table, also contributes to efficient memory management by organizing task-related information in a clear and accessible manner, reducing overhead and improving overall system performance.

Furthermore, the inventive approach creates a particular arrangement of elements and steps that result in a specialized apparatus with a specific functionality. This occurs in numerous ways. First, the embodiments of the invention define specific data structures—the task template table, the task table, and the sub-task table—that are not standard components of a general-purpose computer. These tables, with their defined columns and relationships, create a unique way of organizing and managing task-related data. In addition, embodiments outline a particular process for creating and managing tasks and sub-tasks, including the dynamic creation of ad hoc sub-tasks. This process, as illustrated in FIG. 4, is a specific sequence of steps that transforms the way a computer system handles workflows. Functional specialization is also provided, where the combination of the specialized data structures and the unique workflow process gives the computer system a specific functionality: the ability to manage dynamic workflows with ad hoc sub-tasks. This is not a generic computer function; it is a specialized capability tailored to a particular problem.

### System Architecture Overview

### Additional System Architecture Examples

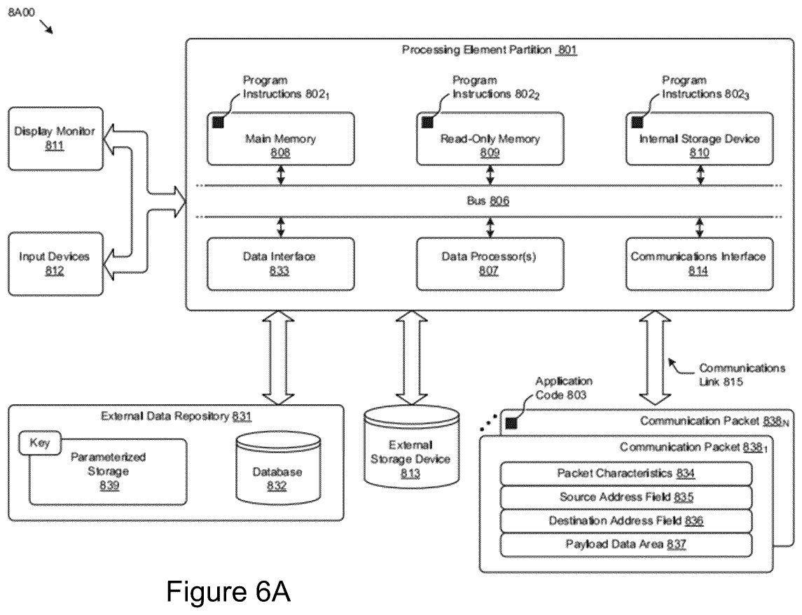

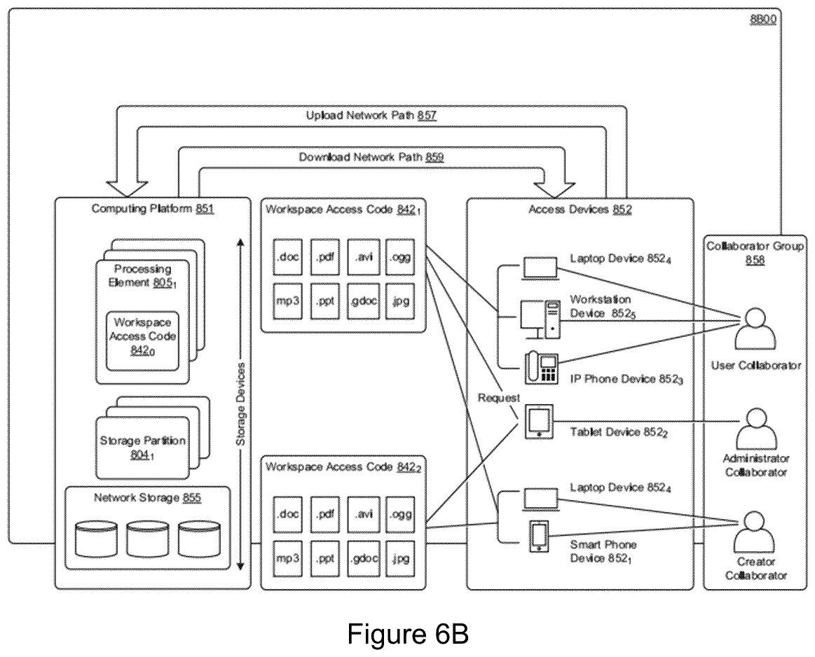

FIG. 6A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to accessing a dynamically extensible set of content object workflows. A module may include one or more state machines and/or combinational logic used to implement or facilitate the operational and/or performance characteristics pertaining to accessing a dynamically extensible set of content object workflows.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of accessing a dynamically extensible set of content object workflows). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations that pertain to accessing a dynamically extensible set of content object workflows, and/or for improving the way data is manipulated when performing computerized operations pertaining to accessing a dynamically extensible set of applications through a content management system to perform workflows over content objects managed by the content management system.

FIG. 6B depicts a block diagram of an instance of a cloud-based environment 8B00. Such a cloud-based environment supports access to workspaces through the execution of workspace access code (e.g., workspace access code 842₀, workspace access code 842₁, and workspace access code 842₂). Workspace access code can be executed on any of access devices 852 (e.g., laptop device 852₄, workstation device 852₅, IP phone device 852₃, tablet device 852₂, smart phone device 852₁, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 805₁). The workspace access code can interface with storage devices such as networked storage 855. Storage of workspaces and/or any constituent files or objects, and/or any other code or scripts or data can be stored in any one or more storage partitions (e.g., storage partition 804₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method, comprising:
creating a workflow in a workflow management system, wherein the workflow management system comprises a workflow control layer having a workflow ad hoc modification module and a workflow database;
implementing the workflow to include one or more tasks, wherein each of the one or more tasks corresponds to a respective entry in the workflow database;
during execution of the workflow, receiving an indication that a sub-task should be created for a task;
using the workflow ad hoc modification module to update the workflow database to create a new entry in the workflow database for the sub-task, wherein the new entry is created while executing the workflow ; and
updating the new entry in the workflow database after execution of the sub-task.

2. The method of claim 1, wherein the new entry in the workflow database for the sub-task corresponds to a parent-child relationship to a parent entry in the workflow database for the task.

3. The method of claim 2, wherein a dependency relationship is enforced between the task and the sub-task, such that all sub-tasks linked to a parent task are completed before confirming that the parent task is finished.

4. The method of claim 1, wherein the sub-task corresponds to new tasks that do not already exist in the workflow and involve assignment of the sub-task to an assignee that does not already have other existing tasks or roles within the workflow.

5. The method of claim 1, wherein a priority order is assigned to the sub-task relative to other sub-tasks.

6. The method of claim 1, wherein a dependency relationship is established for the sub-task relative to other sub-tasks.

7. The method of claim 1, further comprising:
using a task template to implement the task, wherein the task template comprises separate entries for each different type of task,
representing the task as a task entry within a task table structure, wherein the task entry for the task comprises task attributes for the task, the task attributes comprising a task identifier and a task assignee;
representing the sub-task as a sub-task entry in a sub-task table, wherein the sub-task entry comprises sub-task attributes, the sub-task attributes comprising a sub-task identifier, a sub-task assignee, and a link to a parent task.

8. A non-transitory computer readable medium having stored thereon a sequence of instructions which, when stored in memory and executed by one or more processors causes the one or more processors to perform a set of acts, the set of acts comprising:
creating a workflow in a workflow management system, wherein the workflow management system comprises a workflow control layer having a workflow ad hoc modification module and a workflow database;
implementing the workflow to include one or more tasks, wherein each of the one or more tasks corresponds to a respective entry in the workflow database;
during execution of the workflow, receiving an indication that a sub-task should be created for a task;
using the workflow ad hoc modification module to update the workflow database to create a new entry in the workflow database for the sub-task, wherein the new entry is created while in the midst of executing the workflow; and
updating the new entry in the workflow database after execution of the sub-task.

9. The non-transitory computer readable medium of claim 8, wherein the new entry in the workflow database for the sub-task corresponds to a parent-child relationship to a parent entry in the workflow database for the task.

10. The non-transitory computer readable medium of claim 9, wherein a dependency relationship is enforced between the task and the sub-task, such that all sub-tasks linked to a parent task are completed before confirming that the parent task is finished.

11. The non-transitory computer readable medium of claim 8, wherein the sub-task corresponds to new tasks that do not already exist in the workflow and involve assignment of the sub-task to an assignee that does not already have other existing tasks or roles within the workflow.

12. The non-transitory computer readable medium of claim 8, wherein a priority order is assigned to the sub-task relative to other sub-tasks.

13. The non-transitory computer readable medium of claim 8, wherein a dependency relationship is established for the sub-task relative to other sub-tasks.

14. The non-transitory computer readable medium of claim 8, further comprising:
using a task template to implement the task, wherein the task template comprises separate entries for each different type of task,
representing the task as a task entry within a task table structure, wherein the task entry for the task comprises task attributes for the task, the task attributes comprising a task identifier and a task assignee;
representing the sub-task as a sub-task entry in a sub-task table, wherein the sub-task entry comprises sub-task attributes, the sub-task attributes comprising a sub-task identifier, a sub-task assignee, and a link to a parent task.

15. A system comprising:
a storage medium having stored thereon a sequence of instructions; and
one or more processors that execute the sequence of instructions to cause the one or more processors to perform a set of acts, the set of acts comprising: creating a workflow in a workflow management system, wherein the workflow management system comprises a workflow control layer having a workflow ad hoc modification module and a workflow database; implementing the workflow to include one or more tasks, wherein each of the one or more tasks corresponds to a respective entry in the workflow database;
during execution of the workflow, receiving an indication that a sub-task should be created for a task; using the workflow ad hoc modification module to update the workflow database to create a new entry in the workflow database for the sub-task, wherein the new entry is created while in the midst of executing the workflow; and
updating the new entry in the workflow database after execution of the sub-task.

16. The system of claim 15, wherein the new entry in the workflow database for the sub-task corresponds to a parent-child relationship to a parent entry in the workflow database for the task.

17. The system of claim 16, wherein a dependency relationship is enforced between the task and the sub-task, such that all sub-tasks linked to a parent task are completed before confirming that the parent task is finished.

18. The system of claim 15, wherein the sub-task corresponds to new tasks that do not already exist in the workflow and involve assignment of the sub-task to an assignee that does not already have other existing tasks or roles within the workflow.

19. The system of claim 15, wherein a priority order is assigned to the sub-task relative to other sub-tasks.

20. The system of claim 15, wherein a dependency relationship is established for the sub-task relative to other sub-tasks.

21. The system of claim 15, further comprising:
using a task template to implement the task, wherein the task template comprises separate entries for each different type of task,
representing the task as a task entry within a task table structure, wherein the task entry for the task comprises task attributes for the task, the task attributes comprising a task identifier and a task assignee;
representing the sub-task as a sub-task entry in a sub-task table, wherein the sub-task entry comprises sub-task attributes, the sub-task attributes comprising a sub-task identifier, a sub-task assignee, and a link to a parent task.
